(19) United States
(12) Patent Application Publication
(10) Pub. No.: US 2024/0265571 A1
(43) Pub. Date: Aug. 8, 2024

(54) METHOD, APPARATUS, DEVICE AND MEDIUM FOR TRACKING A TARGET OBJECT IN A VIDEO BASED ON AN INSTANCE MOTION

(71) Applicants: Lemon Inc., Grand Cayman (KY); Beijing Youzhuju Network Technology Co., Ltd., Beijing (CN)

(72) Inventors: Song Bai, Singapore (SG); Qihao Liu, Beijing (CN); Junfeng Wu, Beijing (CN); Yi Jiang, Beijing (CN)

(21) Appl. No.: 18/432,448

(22) Filed: Feb. 5, 2024

(30) Foreign Application Priority Data
Feb. 7, 2023 (CN) 202310134169.5

(51) Int. Cl. G06T 7/73; G06T 7/20

(52) U.S. Cl. CPC G06T 7/74; G06T 7/20; G06T 2207/10016

(57) ABSTRACT

A method, device, and medium for tracking a target object in a video based on an instance motion are provided. In one method, for a set of previous frames prior to a target frame in the video, a set of previous positions of the target object in the set of previous frames is obtained respectively. Based on the set of previous positions, a predicted value of a position of the target object in the target frame is determined with a motion model. A measured value of a position of an object in the target frame is determined. Based on a similarity between the predicted value and the measured value, the target object is tracked in the video.

### CROSS-REFERENCE

This application claims priority to Chinese Patent Application No. 202310134169.5, filed on Feb. 7, 2023, the entirety of which is incorporated herein by reference.

### FIELD

Exemplary implementations of the present disclosure generally relate to visual task processing, and more particularly to a method, apparatus, device, and computer readable storage medium for tracking a target object in a video based on an instance motion of the target object.

### BACKGROUND

Machine Learning technology has been widely used to handle visual tasks related to instance perception. For example, in video processing, there may be a large number of fast-moving objects in the video, and there may be varying degrees of occlusion between these objects. Although various object tracking technology solutions have been developed, these technical solutions cannot effectively solve the problems of fast-moving objects and occluded objects, which leads to unsatisfactory performance of object tracking. At this time, how to improve the performance of object tracking in a more effective way has become a difficult and hot topic in the field of visual processing.

### SUMMARY

In a first aspect of the present disclosure, a method of tracking a target object in a video based on an instance motion of the target object is provided. In this method, for a set of previous frames prior to a target frame in the video, a set of previous positions of the target object in the set of previous frames is obtained respectively. A predicted value of a position of the target object in the target frame is determined with a motion model based on the set of previous positions. A measured value of a position of an object in the target frame is determined. The target object is tracked in the video based on a similarity between the predicted value and the measured value.

In a second aspect of the present disclosure, there is provided an apparatus for tracking a target object in a video. The apparatus includes: an obtaining module configured to for a set of previous frames prior to a target frame in the video, obtain a set of previous positions of the target object in the set of previous frames, respectively; a first determination module configured to determine, based on the set of previous positions, a predicted value of a position of the target object in the target frame with a motion model; a second determination module configured to determine a measured value of a position of an object in the target frame; and a tracking module configured to track the target object in the video based on a similarity between the predicted value and the measured value.

In a third aspect of the present disclosure, an electronic device is provided. The electronic device includes: at least one processing unit; and at least one memory, coupled to the at least one processing unit and storing instructions for execution by the at least one processing unit, the instructions, when executed by the at least one processing unit, causing the electronic device to perform the method of the first aspect.

In a fourth aspect of the present disclosure, a computer readable storage medium is provided. The computer-readable storage medium stores a computer program that can be executed by a processor to implement the method of the first aspect.

It would be appreciated that the content described in the Summary section of the present invention is neither intended to identify key or essential features of the implementations of the present disclosure, nor is it intended to limit the scope of the present disclosure. Other features of the present disclosure will be readily envisaged through the following description.

### BRIEF DESCRIPTION OF THE DRAWINGS

Hereinafter, in conjunction with the accompanying drawings and with reference to the following detailed description, the above and other features, advantages and aspects of the various embodiments of the present disclosure will become more apparent. In the drawings, the same or similar reference numerals indicate the same or similar elements, where:

FIG. 1 illustrates a block diagram of an application environment according to an exemplary implementation of the present disclosure;

FIG. 2 illustrates a block diagram for tracking a target object in a video based on an instance motion of the target object according to some implementations of the present disclosure;

FIG. 3 illustrates a block diagram of determining a position of a target object based on a motion model according to some implementations of the present disclosure;

FIG. 4 illustrates a block diagram of a structure of a motion model according to some implementations of the present disclosure;

FIG. 5 illustrates a block diagram of determining a position of a target object based on a motion feature and an image feature according to some implementations of the present disclosure;

FIG. 6 illustrates a block diagram of tracking a target object based on a comparison of a predicted and measured positions of an object according to some implementations of the present disclosure;

FIG. 7 illustrates a block diagram of comparing different tracking results according to some implementations of the present disclosure;

FIG. 8 illustrates a flowchart of a method for tracking a target object in a video based on an instance motion of a target object according to some implementations of the present disclosure;

FIG. 9 illustrates a block diagram of an apparatus for tracking a target object in a video based on an instance motion of the target object according to some implementations of the present disclosure; and

FIG. 10 illustrates a block diagram of a device capable of implementing multiple implementations of the present disclosure.

### DETAILED DESCRIPTION

The embodiments of the present disclosure will be described in more detail below with reference to the accompanying drawings. Although some implementations of the present disclosure are shown in the drawings, it would be appreciated that the present disclosure can be implemented in various forms and should not be interpreted as limited to the implementations described herein. On the contrary, these implementations are provided for a more thorough and complete understanding of the present disclosure. It would be appreciated that the drawings and implementations of the present disclosure are only for illustrative purposes and are not intended to limit the scope of protection of the present disclosure.

In the description of the implementations of the present disclosure, the term “including” and similar terms should be understood as open-ended inclusion, that is, “including but not limited to”. The term “based on” should be understood as “at least partially based on”. The terms “one implementation” or “the implementation” should be understood as “at least one implementation”. The term “some implementations” should be understood as “at least some implementations”. The following may also include other explicit and implicit definitions. As used herein, the term “model” may represent an association between various data. For example, the above association may be obtained based on various technical solutions currently known and/or to be developed in the future.

It should be understood that the data involved in this technical solution (including but not limited to the data itself, data obtaining or use) should comply with the requirements of relevant laws and regulations and relevant provisions.

It should be understood that, before applying the technical solutions disclosed in various implementations of the present disclosure, the user should be informed of the type, scope of use, and use scenario of the personal information involved in the subject matter described herein in an appropriate manner in accordance with relevant laws and regulations, and user authorization should be obtained.

For example, in response to receiving an active request from the user, prompt information is sent to the user to explicitly inform the user that the requested operation would acquire and use the user's personal information. Therefore, according to the prompt information, the user may decide on his/her own whether to provide the personal information to the software or hardware, such as electronic devices, applications, servers, or storage media that perform operations of the technical solutions of the subject matter described herein.

As an optional but non-limiting implementation, in response to receiving an active request from the user, the way of sending the prompt information to the user may, for example, include a pop-up window, and the prompt information may be presented in the form of text in the pop-up window. In addition, the pop-up window may also carry a select control for the user to choose to “agree” or “disagree” to provide the personal information to the electronic device.

It should be understood that the above process of notifying and obtaining the user authorization is only illustrative and does not limit the implementations of the present disclosure. Other methods that satisfy relevant laws and regulations are also applicable to the implementations of the present disclosure.

The term “in response to” used here represents a state where the corresponding event occurs, or the condition is satisfied. It will be understood that the timing of subsequent actions executed in response to the event or condition is not necessarily strongly related to the time when the event occurs or the condition is set. For example, in some cases, subsequent actions can be executed immediately when the event occurs or the condition is satisfied, while in other cases, subsequent actions can be executed after a period of time after the event occurs or the condition is satisfied.

### Example Environment

Object tracking is one of the fundamental tasks of Computer Vision, and it has various downstream applications in areas such as autonomous driving, intelligent monitoring, and content understanding. In the context of the present disclosure, visual data can include video data, and objects can represent entities with tangible shapes in visual data, such as but not limited to characters, animals, objects, and so on. For example, in an autonomous driving environment, various vehicles in the road environment can be identified and tracked; in an intelligent monitoring system, various products in the production process can be identified and tracked, and so on.

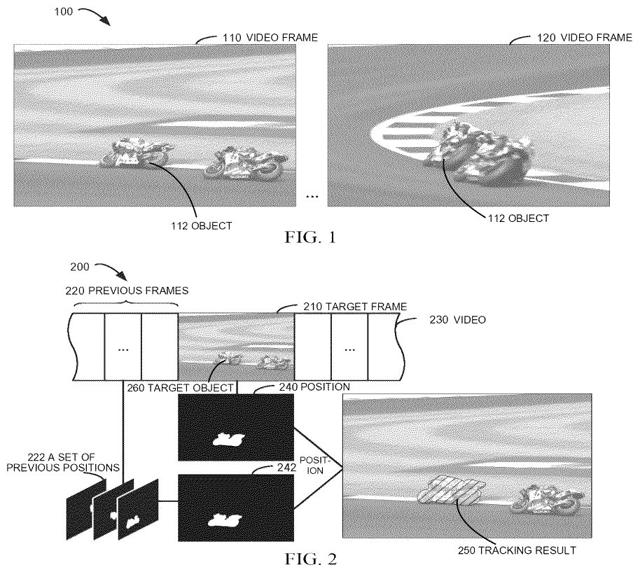

First, refer to FIG. 1 to describe an application environment of object tracking, which illustrates a block diagram of the application environment 100 according to an exemplary implementation of the present disclosure. As shown in FIG. 1, multiple video frames can be included in a video, such as video frames 110 . . . , and 120. An object 112 (such as a red motorcycle on the left, a blue motorcycle on the right, etc.) may be tracked in the multiple video frames.

It will be understood that object 112 may be a moving object, which results in blurring and significant differences in the posture of the same object in different video frames, resulting in differences in the appearance of the same object in different video frames. Furthermore, multiple objects in the video frames may have occlusion, which also results in differences in the appearance of the same object in different video frames. In the context of the present disclosure, the specific representation of an object in respective video frame may be referred to as an instance of an object (instance for short).

Segmenting and tracking object instances in a given video is an important research direction in Computer Vision, which has wide applications in fields such as video understanding, video editing, autonomous driving, and augmented reality. Three representative tasks include Video Object Segmentation (VOS), Video Instance Segmentation (VIS), and Multi-Object Tracking and Segmentation (MOTS). However, technical solutions for performing the above tasks will be affected to varying degrees by the occlusion and rapid motion between objects, which results in longer processing time and reduced accuracy.

In existing technical solutions, video segmentation mostly uses appearance-based object positioning to achieve object tracking across multiple video frames. Specifically, most VOS technical solutions take the previous video frames as target templates, build a feature repository for all objects, and then match the pixel-level features of new video frames based on this feature repository. Online VIS and MOTS technical solutions directly perform video segmentation based on image features, and then use object features for tracking. Although these technical solutions may achieve better technical effects when processing simple videos, these technical solutions are very sensitive to changes in the appearance of objects and difficult to process multiple object instances with similar appearances. Therefore, when dealing with complex scenes with complex motion features, occlusion, or deformation, it will lead to large errors.

In the field of object tracking, it is difficult to effectively handle occlusion between objects and fast-moving objects. The main reason is that the existing technologies extract object features (such as embedding) based largely on the appearance of the object, which are usually easily affected by occlusion and fast motion. Currently, the use of optical flow technology has been proposed to provide motion information. However, optical flow essentially only considers the pixel-level motion of objects, which still heavily relies on the appearance similarity of objects in video frames. Therefore, the accuracy of optical flow technology is not ideal when facing occlusion and fast motion problems.

### Summary of Object Tracking

To at least partially solve the shortcomings in Prior Art, a tracking technology solution of an instance-level motion object is proposed according to an exemplary implementation of the present disclosure. Specifically, Instance Motion for Object-centric Video Segmentation (InstMove) is proposed. Unlike the existing pixel-by-pixel motion processing, InstMove mainly relies on instance-level motion information, which does not represent the instance features of the image level but represents a physical interpretation of the object instance, that is, a physical motion mode. This enables the technical solution of the present disclosure to process object occlusion and fast-moving problems in videos in a more effective way.

Hereinafter, a summary of an exemplary implementation according to the present disclosure is described with reference to FIG. 2, which illustrates a block diagram 200 for tracking a target object in a video based on an instance motion according to some implementations of the present disclosure. As shown in FIG. 2, a video 230 may include multiple video frames, each of which may be processed one by one in chronological order to track the target object among multiple video frames. The video frame 230 may include a target frame 210 and one or more previous frames 220 prior to the target frame 210. Each video frame may be processed one by one in a similar manner. Here, the target frame 230 is a video frame currently being processed, and it is desired to track a target object 260 (e.g., the red motorcycle) in the target frame 230.

At this time, a set of previous positions 222 of target object 260 in the set of previous frames 220 may be obtained respectively. In the context of the present disclosure, the position of the object may be represented in various ways, such as using a mask and/or a bounding box to represent the position of the object. When using the mask, a contour of the object may be determined more accurately, thereby achieving object segmentation. When using the bounding box, the speed of object tracking may be improved and the tracking efficiency may be improved.

A predicted value of a position 242 of the target object 260 in the target frame 210 may be determined based on the set of previous positions 222. For example, a motion model may be used to describe a motion pattern of the target object 260 among different frames, and then the position 242 may be determined based on the motion model. Object segmentation may be performed for the target frame 210 to determine a measured value of a position 240 of an object (e.g., one or more objects) in the target frame 210, and then the target object 260 may be tracked in the video 230 based on a similarity between the two positions 240 and 242, and a tracking result 250 may be output.

It will be understood that, unlike the optical flow technology solution that estimates pixel-level motion, InstMove may directly learn instance-level motion and deformation from instance masks in previous video frames, and may predict the position and shape of the target object in the current video frame in a more accurate and robust manner. In this way, high tracking accuracy may be provided even in scenes with occlusion relationships and fast motion. In other words, the position 242 at this time is a predicted position based on the historical motion of the target object 260, so the position may better match the historical motion trend of the target object 260, thereby improving the accuracy of the tracking result 250.

According to an exemplary implementation of the present disclosure, InstMove may directly use instance masks to model the physical existence of objects, and learn dynamic models through memory networks to predict the position and shape of object instances in the next video frame. Using the exemplary implementations of the present disclosure, instance-level motion features may provide more robust and accurate support for video segmentation tasks. Especially in videos involving complex scenes, higher accuracy may be provided for video segmentation tasks. Furthermore, InstMove technology solution may be integrated into other current downstream visual processing models to improve the performance of downstream tasks.

### Detailed Process of Object Tracking

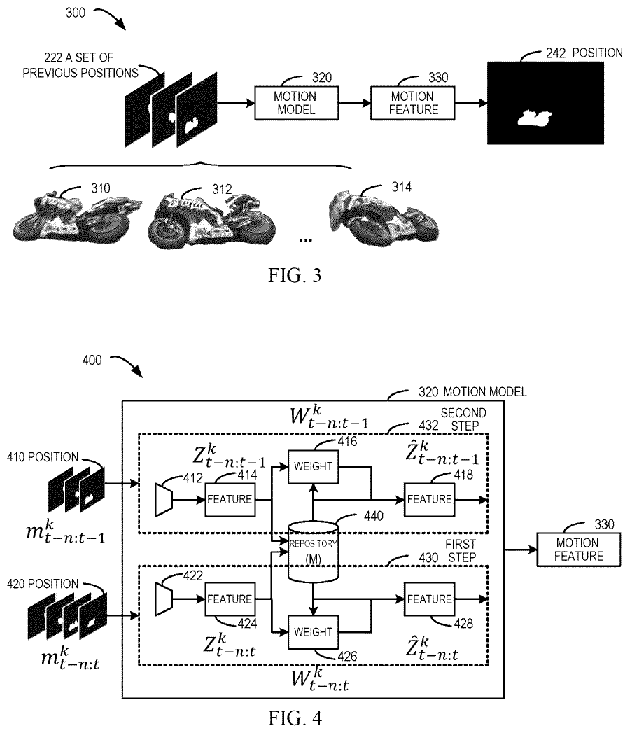

A summary of an exemplary implementation of the present disclosure has been described with reference to FIG. 2. Hereinafter, more details on performing object tracking based on a motion model are described with reference to FIG. 3. FIG. 3 illustrates a block diagram 300 for determining a position of a target object based on a motion model according to some implementations of the present disclosure. As shown in FIG. 3, the set of previous positions 222 may include, for example, masks of the target object identified from various previous frames, where the target object may be in different postures, such as postures 310, 312 . . . , and 314. At this point, a motion model 320 may utilize masks of the same target object identified from previous video frames to learn the motion trend of the target object. For example, a motion feature 330 may be used to identify the motion trend of the target object. Furthermore, the position 242 of the target object in subsequent video frames may be determined based on the corresponding the motion feature 330.

According to an exemplary implementation of the present disclosure, the motion model 320 may be obtained based on historical data, which may describe an association between a position of an object in a target frame in a video and a set of positions of the object in a set of previous frames respectively prior to the target frame. It will be understood that the motion model 320 here may be a model trained based on various techniques known in the past and/or to be developed in the future, and may guide the process of processing subsequent video frames based on motion trends learned from previous historical motion data. Specifically, assuming that a set of previous positions represents that the object has been moving uniformly along a straight line in the past, the position of the object in subsequent frames may be predicted based on physical motion patterns related to uniform straight line motion, thereby improving the accuracy of object tracking. Furthermore, a predicted value of the position 242 of the target object in the target frame may be determined based on the motion model 320 and a set of previous positions.

According to an exemplary implementation of the present disclosure, by constructing a motion model and providing InstMove, the distance between the two working lines of the optical flow-based technical solution and the speed-based technical solution may be reduced. InstMove may provide simple and efficient motion prediction and has the advantages of both technical solutions above. First, it is portable and compatible with the method of video segmentation tasks. In addition, InstMove may provide high-dimensional information of position and shape, which may be used by downstream tasks in various ways. Furthermore, InstMove may learn the physical features of objects and then model the motion trend of objects, thereby improving the accuracy of handling problems such as occlusion between objects and fast object movement.

See FIG. 4 for more details on the motion model 320, which illustrates a block diagram 400 of a structure of the motion model 320 according to some implementations of the present disclosure. As shown in FIG. 4, the motion model 320 may include a repository 440 (represented by a symbol M) for storing motion features of one or more objects identified from the video. Here, each object may have its respective motion feature, specifically, the red motorcycle and the blue motorcycle may have their own motion features. For example, the motion feature of the red motorcycle may correspond to an association between the position of the red motorcycle in the target frame in the video and a set of positions in the previous frames prior to the target frame. That is, the motion feature may describe the motion trend of the object over a period of time and may serve as guiding information for predicting the position of the object in one or more subsequent video frames.

According to an exemplary implementation of the present disclosure, instance masks may be directly used to represent the position and shape of objects, and a repository may be provided for modules of Recurrent Neural Networks (RNN) in order to store motion features extracted from previous masks, and then predict the position of objects in the next frame based on motion features. Specifically, a binary mask of an object instance may be directly used to represent the shape and position of an instance, and predict the motion of the instance. First, the meanings of multiple parameters involved in the motion model are introduced. Iₜ∈ [symbol] ^{w×h×3} may be used to represent the t^{th} video frame in an input video, where [symbol] represents feature space, w represents a width of the video frame, h represents a height of the video frame, and 3 represents three color channels of RGB. mₜ^{k}∈ [symbol] ^{w×h} represents the binary mask of the k^{th} instance in the t^{th} video frame.

According to an exemplary implementation of the present disclosure, motion features may be extracted from one or more previous video frames and instance masks in the next video frame may be predicted. To learn instance-level motion, the video frame may be divided into multiple parts based on instance recognition, including only one instance in each part. At this point, all pixels in each part may be regarded as a unit.

As shown in FIG. 4, in a first step 430, the training data may be obtained, that is, a reference position of a reference object in a target reference frame in a reference video and a set of previous reference positions of the reference object in a set of previous reference frames respectively prior to the target reference frame may be obtained respectively. Specifically, assuming that the video frame currently being processed is the t^{th} frame, and for the k^{th} object, the n previous positions 420 of the object in the previous n frames may be obtained (i.e., n masks: m_{t-n:t}^{k}). Here, based on the reference position (i.e., the mask of the t^{th} frame: mₜ^{k}) and a set of previous reference positions (i.e., masks from (t−n)^{th} frame to (t−1)^{th} frame: m_{t-n:t-1}^{k}), the motion feature in the repository 440 of the motion features in the motion model 320 may be determined.

The goal of motion model 320 is to learn the motion and deformation from mₜ₋ₙ^{k} to mₜ₋₁^{k} (where n≥2), and then predict the shape and position of the instance in the t^{th} video frame, represented by mₜ^{k}. In other words, one or more previous video frames may be taken as input in order to predict the mask of the instance in the current video frame. Specifically, the above learning goal may be represented by the following formula: mₜ^{k}=F(m_{t-n:t-1}^{k}), ∀n≥2, where F represents a motion module.

According to an exemplary implementation of the present disclosure, a Convolutional Neural Network (CNN) may be used, and a instance mask mⁱ may be used to represent the position and shape of the instance. The training phase may include two steps, for example, the first step 430 and a second step 432. In the first step 430, a true value mask m_{t-n:t}^{k} and m_{t-n:t-1}^{k} may be provided, and only the repository M is updated during the training phase. In the second stage 432, a predicted mask m_{t-n:t}^{k} of the target video segmentation is directly used as input in order to predict the mask mₜⁱ.

As shown in FIG. 4, an encoder 422 (represented as q_{Ø}) may be used to perform the encoding process on a position 420 in order to obtain a feature 424 (i.e., Z_{t-n:t}^{k}). According to an exemplary implementation of the present disclosure, a Gaussian distribution model may be used to model motion and sample a latent variable Zₜ from the distribution for prediction. During training, the encoder may be used to learn the motion feature represented by Zₜ. For example, a Conditional Variational Autoencoder (CVAE) model may be used to represent the motion feature of the instance as a latent variable model. The repository 440 may be maintained to store representative motion features. Then, in the inference phase, the motion features in the repository M may be used to help refine incomplete motion patterns extracted only from previous video frames m_{t-n:t-1}^{k}, and a refinement pattern containing instance-level motion information may be used to assist in predicting mₜ^{k} of the next video frame.

During the training process, the encoder 422 may be used to learn the motion feature z_{t-n:t}^{k}=q_{ϕ}(m_{t-n:t}^{k}) by accessing the target mask mₜⁱ. Here, q_{ϕ} is directly used to regress a vector of length l. Then, the corresponding attention weight vector w_{1:t}^{k}∈ [symbol] ^{c} is used to store the motion feature z_{t-n:t}^{k}∈ [symbol] ^{l} in the repository M∈ [symbol] ^{c×l}. Specifically, assuming a storage vector of repository M is represented as mᵢ∈ [symbol] ^{l}, i=1, . . . , c, a softmax function may be used to determine the i^{th} element, that is, a weight 426 (represented as w_{t-n:t}^{k}):

$${w}_{1 : t , i}^{k} = \frac{exp \{ {S}_{cos} ( {z}_{t - n : t}^{k} , {m}_{i} ) \}}{{\sum }_{j = 1}^{c} exp \{ {S}_{cos} ( {z}_{t - n : t}^{k} , {m}_{j} ) \}} \qquad Formula 1$$

In Formula 1,

$${S}_{cos} ( a , b ) = \frac{a \cdot b}{‖ a ‖ \cdot ‖ b ‖}$$

represents a cosine similarity between vectors a and b. The weight vector wₜ^{k} represents a non-negative weight vector, and the sum of all weight vectors is 1. This weight vector supports accessing repository. Given a latent variable, the corresponding storage feature may be obtained:

$$\hat{z} = w M = {\sum }_{i = 1}^{c} {w}_{i} {m}_{i} \qquad Formula 2$$

The parameters of repository M may be updated through backpropagation, and the repository M may explicitly store different motion features, and then a given motion feature z_{t-n:t}^{k} may be retrieved from the repository. Assuming that the video includes the red and blue motorcycles, the repository M in the trained motion model may include motion features of the red and blue motorcycles. In the first step 430, a feature 428 (\hat{z}_{t-n:t}^{k}) may be obtained, which is the motion feature obtained based on frames from (t−n)^{th} frame to (t−1)^{th} frame.

Further, in the second step 432, a retrieval model in the motion model may be determined based on the set of previous reference positions, and the retrieval model is used to retrieve a motion feature that match the set of previous reference positions from the repository of motion features. Specifically, as shown in FIG. 4, given the trained repository M and input mask m_{t-n:t-1}^{k}, another encoder 412 (represented as p_{θ}) may be used to retrieve the motion feature Z_{t-n:t-1}^{k}=p_{θ}(m_{t-n:t-1}^{k}) from the repository.

During the inference stage, only the input m_{t-n:t-1}^{k} is used to calculate the latent variable with p_{θ} and retrieve the motion feature from the repository M. In other words, after the motion model has been trained, the predicted value may be determined based on the motion model and the set of previous positions. Specifically, the motion feature that match the set of previous positions may be retrieved in the repository of motion features based on the retrieval model and the set of previous positions. Furthermore, the feature of the position of the target object in the target frame may be determined based on the retrieved feature motion. Specifically, a feature 414 (z_{t-n:t-1}^{k}) may be obtained, and retrieval is performed in the repository 440 in orser to obtain a corresponding weight 416 (w_{t-n:t-1}^{k}), and then obtain the corresponding a feature 418 (\hat{z}_{t-n:t-1}^{k}), that is, the motion feature obtained based on frames from (t−n)^{th} frame to (t−1)^{th} frame.

Here, p_{θ} and q_{ϕ} may share the same architecture but have different parameters. Then, Formulas 1 and 2 may be used to access the repository in order to match z_{t-n:t-1}^{k} with the learned motion features and retrieve the corresponding motion features/prior \hat{z}_{t-n:t-1}^{k}. In this second step 432, only the retrieval is performed but the repository M is not updated. Specifically, when tracking the red motorcycle, by inputting the previous mask of the red motorcycle to the motion model, the motion feature of the red motorcycle may be retrieved from the repository M, and then the mask of the red motorcycle in the target frame may be obtained. At this time, the mask is obtained based on the historical motion of the object, which helps to alleviate the problem of low tracking efficiency caused by high-speed motion of the object and/or occlusion between objects.

With the exemplary implementation of the present disclosure, motion prediction may be performed with the repository 440. With the repository 440, the feature 418 may be determined using an RNN-based network to predict the corresponding mask mₜ^{k} in the target frame. For each iteration, in the first step 430, the input m_{t-n:t}^{k} is used to train the encoder q_{ϕ} and the parameters of the repository M. Then, the target mask mₜ^{k} is predicted using \hat{z}_{(·)}^{k}=\hat{z}_{(t-n:t)}^{k}. In the second step 432, the parameters of repository 440 may be fixed and feed m_{t-n:t-1}^{k} to the encoder p_{θ}. In this step, only the encoder p_{θ} is trained and \hat{z}_{(·)}^{k}=\hat{z}_{(t-n:t-1)}^{k} is used for prediction. In this way, two encoders may be trained respectively, thereby completing the training process of the entire motion model.

According to an exemplary implementation of the present disclosure, image-related features from previous video frames may be integrated to enhance the motion feature of target video frames, thereby improving the robustness in processing motion blur, appearance changes, and deformation issues of video objects. At this time, a set of features from previous positions may be used to update the relevant motion feature of the target object. More details are described with reference to FIG. 5, which illustrates a block diagram 500 for determining a position of a target object based on motion features and image features according to some implementations of the present disclosure.

As shown in FIG. 5, the position 410 is encoded with an encoder (such as a mask encoder Eₘ) 510 and input into a network model 520. Specifically, a mask feature f_{t-n:t-1}^{k}=L(Eₘ(m_{t-n:t-1}^{k})) may be extracted using a Long Short Term Memory network (LSTM) L. At the same time, the position 410 may be input into the motion model 320 in order to obtain the motion feature \hat{z}_{(·)}^{k} based on the method described above. Then, the mask feature f_{t-n:t-1}^{k} and the retrieved motion feature \hat{z}_{(·)}^{k} are concatenated together. Afterwards, the concatenated features are fed to the mask decoder Dₘ to predict the target mask mₜ^{k}=Dₘ (f_{t-n:t-1}^{k},\hat{z}_{(·)}^{k}). In this way, different network branches may be used and more information may be considered when determining the position 242, thereby improving the accuracy of determining the position 242.

According to an exemplary implementation of the present disclosure, the feature of the position of the target object in the target frame may be updated further utilizing the feature of the measured value of the mask identified in the target frame 210. It will be appreciated that this step is optional and is intended to further improve the accuracy of determining the position 242.

According to an exemplary implementation of the present disclosure, image features may be used to optimize mask boundaries, that is, the feature of the measured values of the mask identified in the target frame 210 may be further utilized to update the motion features related to the target object. It will be understood that this step is optional and is intended to further improve the accuracy of determining position 242. Specifically, to obtain more accurate shape estimates, image features may be used to refine mₜⁱ at the final position of the model. For example, the first two stages of ResNet-50 may be used as an image encoder to extract low-level features from the original video frame, and feature maps of 8 stride and 4 stride may be generated respectively. The feature maps will be upsampled twice and added to the motion feature in a decoder. It will be understood that this step is optional and video segmentation tasks may also be performed directly using motion features.

In the network structure shown in FIG. 5, for a given input mask m_{t-n:t-1}^{k}, the mask encoder 510 (represented as Eₘ) may be used to subsequently extract the mask feature f_{t-n:t-1}^{k}=L(Eₘ(m_{t-n:t-1}^{k})) using a Long Short Term Memory model L. Then, the mask feature f_{t-n:t-1}^{k} is concatenated with the retrieved motion feature \hat{z}_{(·)}^{k}. Afterwards, the concatenated feature is fed to the mask decoder Dₘ to predict the target mask mₜ^{k}=Dₘ (f_{t-n:t-1}^{k}, \hat{z}_{(·)}^{k}).

With the exemplary implementation of the present disclosure, a dual-branch model (including a motion branch and an appearance branch) may be used to process videos. At this time, the motion branch may extract the motion features of objects in the respective frame in the video, and the appearance branch may extract the appearance features of objects in the video. By combining the features of the two aspects, objects may be described in a more effective and accurate way, thereby improving the accuracy of video segmentation.

According to an exemplary implementation of the present disclosure, since the predicted motion mₜⁱ is in the form of a binary mask, the mask loss [symbol] ₘₐₛₖ commonly used in instance segmentation may be used to supervise the learning of the motion. It is defined as a combination of a Dice loss function and a focus loss function: [symbol] ₘₐₛₖ=λ_{focal} [symbol] _{fical}+λ_{dice} [symbol] _{dice}. The following parameters may be set: λ_{focal}=1 and λ_{dice}=5. Alternatively, and/or additionally, the above parameters may be set to other values, such as 1.5 and 4.5, respectively, and so on.

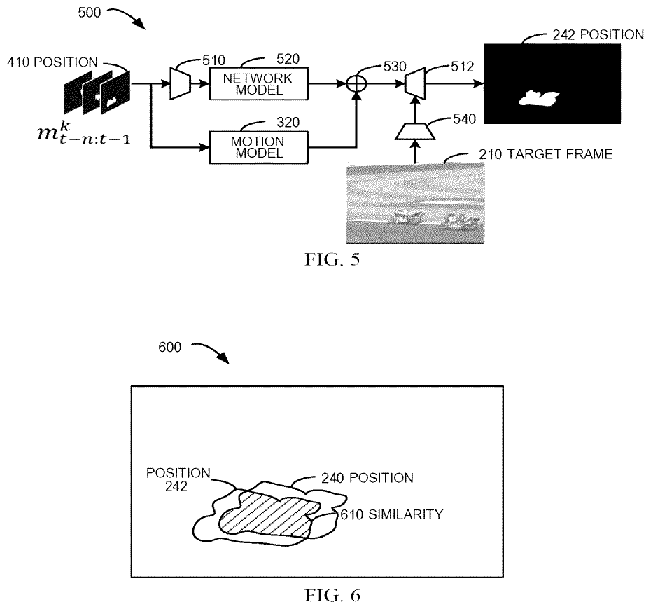

According to an exemplary implementation of the present disclosure, the target object may be tracked based on the similarity between the predicted and measured positions of the object. See FIG. 6 for more details, which illustrates a block diagram 600 for tracking a target object based on a comparison of predicted and measured positions of an object according to some implementations of the present disclosure. As shown in FIG. 6, a similarity 610 between positions 240 and 242 may be represented based on the intersection ratio, and object tracking may be performed accordingly. According to an exemplary implementation of the present disclosure, the position of each object in the target frame may be identified based on object segmentation technology, and then the position obtained based on the motion model may be compared with the position of each identified object to determine the location of the target object.

According to an exemplary implementation of the present disclosure, a threshold condition may be preset. For example, when the intersection ratio is greater than 70% (or other numerical value), an object at the position corresponding to the measured value in the target frame is identified as the target object. Specifically, a higher intersection ratio indicates that the area determined based on image recognition and the model determined based on motion model have a greater degree of overlap. At this time, the identified position may be considered as the position where the target object is located.

For further example, if it is determined that the similarity does not meet the threshold condition, the object at the position corresponding to the measured value in the target frame is identified as an object other than the target object. At this time, the overlap between the area determined based on image recognition and the model determined based on motion model is small, so the identified position 240 may be considered as the position of other objects. Since the motion model may estimate the motion trend of the target object in a more accurate way, the accuracy of tracking moving objects (especially high-speed moving objects) may be improved.

According to an exemplary implementation of the present disclosure, each video frame in the video may be processed in chronological order. Specifically, after the position of the target object in the target frame (the t^{th} frame) has been identified, subsequent frames may be processed in a similar manner. The measured value of the position of the target object determined from the target frame may be used as the previous positions of the target object in the target frame. In this way, the latest identified position in the target frame may be used as historical data for processing the next target frame, so that all video frames may be continuously processed in chronological order.

For a next target frame (the (t+1)^{th} frame) subsequent to the target frame in the video, a further set of previous positions of the target object in a further set of previous frames (from (t−n+1)^{th} frame to t^{th} frame) prior to the next target frame is obtained respectively. Furthermore, based on the further set of previous positions m_{t-n:t-1}^{k}, a further predicted value mₜ₊₁^{k} of the position of the target object in the next target frame may be determined. The position of one or more objects may be identified from the (t+1)^{th} frame, that is, the measured value of the position of respective object in the (t+1)^{th} frame is obtained, and the target object is tracked in the video based on similarity comparison.

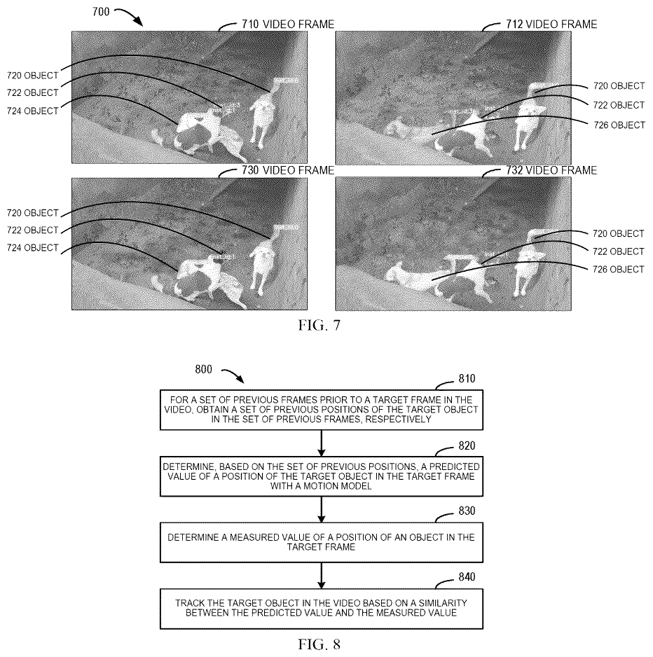

In the following text, referring to FIG. 7, a diagram illustrating the tracking results obtained with existing technical solutions and InstMove is described. FIG. 7 illustrates a block diagram 700 of comparing different tracking results according to some implementations of the present disclosure. As shown in FIG. 7, video frames 710 and 712 illustrate the tracking results obtained using existing technical solutions for object tracking, respectively. In the video frame 710, objects 720 (yellow dog), 722 (black and white dog), and 724 (white dog) are identified, and objects 720, 722, and 726 are identified in the video frame 712. In the video frame 712, although the object of the white dog is identified, due to issues such as object occlusion and object movement, the object is incorrectly identified as a new object 726. At this time, the accuracy of object tracking is not satisfactory.

Video frames 730 and 732 illustrate the tracking results obtained by object tracking with existing technical solutions. At this time, objects 720 (yellow dog), 722 (black and white dog), and 724 (white dog) are identified in the video frame 730, and objects 720, 722, and 724 are identified in the video frame 732. At this time, the motion model may more accurately describe the motion trend of object 724, so the white dog in the video frames 730 and 732 is identified as the same object 724. In other words, the accuracy of object tracking is greatly improved at this time.

According to an exemplary implementation of the present disclosure, the InstMove of the present disclosure may be applied to various downstream tasks such as MOT, VOS, and VIS. For example, historical motion data may be used to model the motion model of various objects in the video. For example, corresponding motion features may be established for each person in a crowded environment, thereby improving the problem of sudden disappearance or sudden appearance of certain personnel due to occlusion and rapid movement.

Compared to existing velocity models and optical flow models, instance-level motion may describe the fine grain appearance information of objects and the physical meaning of motion. Instance-level motion may more effectively solve the problems of object occlusion and fast motion. Furthermore, instance-level motion may be integrated into various existing technical solutions to improve its performance in complex scenarios.

According to an exemplary implementation of the present disclosure, an object-centric video segmentation plug-in may be provided. InstMove may be used as a plug-in to perform different downstream tasks, and two direct ways to call the motion module may be provided: (1) To assist in the tracking process, motion prediction may be used to obtain motion scores and combined with the original matching scores embedding similarity; (2) To improve segmentation quality, motion masks may be used as attention maps and concatenated with feature maps in the decoder.

The motion model according to the present disclosure may be called in a process for executing downstream tasks, so that the performance of multiple downstream tasks is improved. Experiments show that, especially in complex scenes with inter-object occlusion and/or rapid object motion, using instance-level motion features can greatly improve the accuracy of performing tasks.

For VIS tasks, classical CrossVIS and/or SOTA-based MinVIS and IDOL may be used as base lines. To avoid randomness introduced during the training process, only the inference stage of the VIS model is changed, and official pre-trained weights are loaded for inference. Specifically, CrossVIS uses a cosine similarity between features and combines hints of box positions with classification results to obtain matching scores, which are used to assign instances in the current video frame to existing trajectories. Therefore, previous masks in existing trajectories may be used to predict the motion mask of the instance in the current frame, and then the intersection ratio of the mask between the motion mask and instance segmentation result may be calculated as the motion score. Finally, the motion score may be added to the original matching score to help track the process using motion. For IDOL technology solutions, contrast features may be used to calculate bidirectional softmax scores, thereby assigning objects in the current frame.

Furthermore, tracking in MinVIS is accomplished by applying the Hungary algorithm on the score matrix S, which represents the cosine similarity of the query features. To avoid introducing redundant information, the motion scores can be calculated only for a predetermined number (e.g., the first 20, or other numbers) of trajectories with the highest confidence score. The setting of MOTS is similar to VIS, and downstream tasks may be implemented based on PCAN and Unicorn technical solutions. For example, object tracking may be achieved using bidirectional softmax between instance features as the matching score. Motion scores may be added in the same way to introduce motion information to improve tracking quality.

For VOS tasks, downstream tasks may be implemented based on STCN technical solutions. For example, a corresponding repository may be constructed for each object in the video, and the features in the repository may be read to decode them into predicted masks when processing the next video frame. A convolution layer may be added to the decoder to process the concatenation of motion masks and feature maps. The STCN may be retrained to adapt to the input of motion information and load motion modules to generate motion masks during training.

According to an exemplary implementation of the present disclosure, the technical solutions described above may be performed on multiple public datasets. For example, for the VIS task, motion prediction may be performed on the OVIS dataset as well as the OVIS sparse dataset. OVIS is a relatively new and challenging dataset. It includes 607 training videos, 140 validation videos, and 154 test videos. The videos in this dataset are longer, with an average duration of 12.77 seconds and annotation granularity ranging from 3 to 6 FPS. Videos in OVIS record objects with severe occlusion, complex motion features, and rapid deformation. OVIS sparse is a subset of the OVIS dataset that processes longer videos at a lower sampling rate. The videos in OVIS may be sparsely sampled and the OVIS sparse dataset may be obtained.

TABLE 1
Test results of implementing InstMove on different datasets

| | OVIS | | | | | | OVIS sparse | | | | | |
|---|---|---|---|---|---|---|---|---|---|---|---|---|
| method | AP | Δ_{AP} | AP₅₀ | AP₇₅ | AR₁ | AR₁₀ | AP | Δ_{AP} | AP₅₀ | AP₇₅ | AR₁ | AR₁₀ |
| CrossVIS | 12.6 | | 28.4 | 10.8 | 8.9 | 17.1 | 7.0 | | 16.8 | 5.5 | 6.1 | 11.0 |
| CrossVIS + | 16.7 | +4.1 | 35.1 | 15.0 | 10.0 | 21.6 | 8.9 | +1.9 | 20.7 | 7.0 | 7.4 | 13.3 |
| InstMove | | | | | | | | | | | | |
| MinVIS | 26.2 | | 48.2 | 25.0 | 14.4 | 30.1 | 15.3 | | 31.8 | 13.6 | 10.1 | 20.6 |
| MinVIS + | 27.6 | +1.4 | 51.0 | 26.4 | 14.4 | 31.5 | 18.2 | +2.9 | 36.9 | 16.0 | 11.2 | 23.3 |
| InstMove | | | | | | | | | | | | |
| IDOL | 29.2 | | 49.8 | 29.1 | 14.8 | 37.0 | 16.5 | | 34.0 | 15.3 | 10.3 | 25.9 |
| IDOL + | 30.7 | +1.5 | 51.4 | 30.9 | 15.0 | 37.7 | 18.5 | +2.0 | 37.8 | 16.8 | 10.7 | 27.0 |
| InstMove | | | | | | | | | | | | |

Table 1 illustrates the experimental results of performing video instance segmentation based on InstMove on the OVIS dataset and the OVIS sparse dataset. Table 1 illustrates a comparison of the accuracy of the existing CrossVIS technical solutions, the Min VIS technical solution and the IDOL technical solution with the technical solutions after adding the InstMove to the above technical solutions. As shown in Table 1, after adding the InstMove, the accuracy of video segmentation will be greatly improved.

TABLE 2
Comparison between optical flow technology and InstMove

| | |
|---|---|
| OVIS | OVIS sparse |

| method | mAP(↑) | IOU(↑) | mAP(↑) | IOU(↑) |
|---|---|---|---|---|
| RAFT | 46.3 | 64.2 | 30.6 | 49.5 |
| InstMove | 67.8 | 79.2 | 57.3 | 70.7 |

Table 2 illustrates the comparison results of the optical flow technology and InstMove. As can be seen from Table 1, compared with the RAFT technical solution based on optical flow, using the InstMove processing model can greatly improve the accuracy of video segmentation. In the context of the present disclosure, the proposed InstMove learns a dynamic model of an object by modeling its physical existence of the object using an instance mask. Compared with the velocity model and the optical flow-based motion model, the InstMove has fine-grained information and physical meaning of objects. It provides robust additional information in complex scenes and is conducive to improving the performance of object tracking.

### Example Process

FIG. 8 illustrates a flowchart of a method 800 of tracking a target object in a video based on an instance motion according to some implementations of the present disclosure. At block 810, for a set of previous frames prior to a target frame in the video, a set of previous positions of the target object in the set of previous frames is obtained respectively. At block 820, a predicted value of a position of the target object in the target frame is determined with a motion model based on the set of previous positions. At block 830, a measured value of a position of an object in the target frame is determined. At block 840, the target object is tracked in the video based on a similarity between the predicted value and the measured value.

According to an exemplary implementation of the present disclosure, d determining the predicted value of the position of the target object in the target frame comprises: obtaining the motion model that describes an association between a position of an object in a target frame in a video and a set of positions of the object in a set of previous frames respectively prior to the target frame; and determining, based on the motion model and the set of previous positions, the predicted value of the position of the target object in the target frame.

According to an exemplary implementation of the present disclosure, obtaining the motion model comprises: obtaining a reference position of a reference object in a target reference frame in a reference video, and a set of previous reference positions of the reference object in a set of previous reference frames respectively prior to the target reference frame; and determining a motion feature in a repository in the motion model based on the reference position and the set of previous reference positions, the motion feature describing an association corresponding to the reference object.

According to an exemplary implementation of the present disclosure, the method further comprises: determining, based on the set of previous reference positions, a retrieval model in the motion model for retrieving from the repository a motion feature that matches the set of previous reference positions.

According to an exemplary implementation of the present disclosure, determining the predicted value based on the motion model and the set of previous positions comprises: retrieving, based on the retrieval model and the set of previous positions, a motion feature in the repository that matches the set of previous positions; and determining, based on the retrieved motion feature, the predicted value of the position of the target object in the target frame.

According to an exemplary implementation of the present disclosure, determining the predicted value further comprises: updating the motion feature with a feature of the set of previous positions; and determining, based on the updated motion feature, the predicted value of the position of the target object in the target frame.

According to an exemplary implementation of the present disclosure, the method further comprises: updating the motion features with a feature of the measured value.

According to an exemplary implementation of the present disclosure, tracking the target object based on the similarity comprises: in response to determining that the similarity meets a threshold condition, identifying the object at a position corresponding to the measured value in the target frame as the target object.

According to an exemplary implementation of the present disclosure, tracking the target object based on the similarity comprises: in response to determining that the similarity does not meet a threshold condition, identifying the object at a position corresponding to the measured value in the target frame as an object other than the target object.

According to an exemplary implementation of the present disclosure, the method further comprises: for a next target frame subsequent to the target frame in the video, obtaining a further set of previous positions of the target object in a further set of previous frames prior to the next target frame, respectively; determining, based on the further set of previous positions, a further predicted value of a position of the target object in the next target frame; determining a further measured value of a position of an object in the next target frame; and tracking the target object in the video based on a similarity between the further predicted value and the further measured value.

According to an exemplary implementation of the present disclosure, obtaining the further set of previous positions respectively comprises: taking the measured value of the position of the target object determined from the target frame as the previous position of the target object in the target frame.

### Example Devices and Equipment

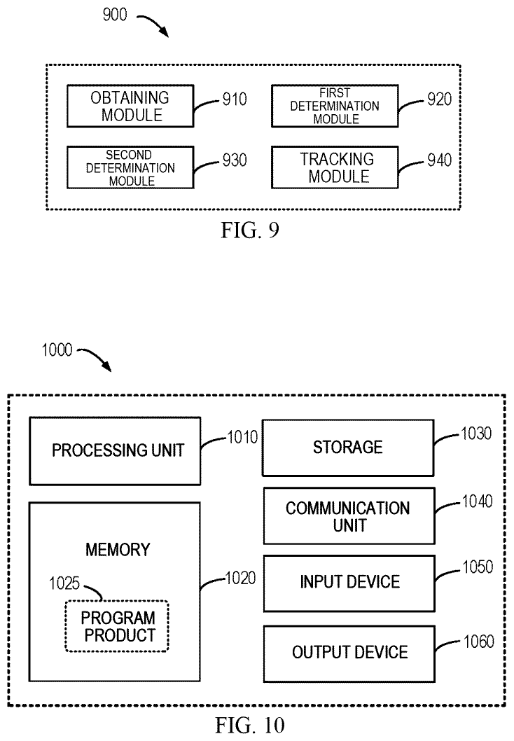

FIG. 9 illustrates a block diagram of an apparatus 900 for tracking a target object in a video based on an instance motion of the target object according to some implementations of the present disclosure. The apparatus 900 includes: an obtaining module 910 configured to for a set of previous frames prior to a target frame in the video, obtain a set of previous positions of the target object in the set of previous frames, respectively; a first determination module 920 configured to determine, based on the set of previous positions, a predicted value of a position of the target object in the target frame with a motion model; a second determination module 930 configured to determine a measured value of a position of an object in the target frame; and a tracking module 940 configured to track the target object in the video based on a similarity between the predicted value and the measured value.

According to an exemplary implementation of the present disclosure, the first determination module includes: a model obtaining module configured to obtain the motion model that describes an association between a position of an object in a target frame in a video and a set of positions of the object in a set of previous frames respectively prior to the target frame; and a prediction module configured to determine, based on the motion model and the set of previous positions, the predicted value of the position of the target object in the target frame.

According to an exemplary implementation of the present disclosure, the model obtaining module includes: a reference data obtaining module configured to obtain a reference position of a reference object in a target reference frame in a reference video, and a set of previous reference positions of the reference object in a set of previous reference frames respectively prior to the target reference frame; and a feature determination module configured to determine a motion feature in a repository in the motion model based on the reference position and the set of previous reference positions, the motion feature describing an association corresponding to the reference object.

According to an exemplary implementation of the present disclosure, the apparatus further comprises: a retrieval model determination module configured to determine, based on the set of previous reference positions, a retrieval model in the motion model for retrieving from the repository a motion feature that matches the set of previous reference positions.

According to an exemplary implementation of the present disclosure, the prediction module includes: a retrieval module configured to retrieve, based on the retrieval model and the set of previous positions, a motion feature in the repository that matches the set of previous positions; and a retrieval-based prediction module configured to determine, based on the retrieved motion feature, the predicted value of the position of the target object in the target frame.

According to an exemplary implementation of the present disclosure, the retrieval-based prediction module further includes: an update module configured to update the motion feature with a feature of the set of previous positions; and the retrieval-based prediction module is further configured to determine, based on the updated motion feature, the predicted value of the position of the target object in the target frame.

According to one exemplary implementation of the present disclosure, the update module is further configured to update the motion features with a feature of the measured value.

According to an exemplary implementation of the present disclosure, the tracking module comprises: a first identification module configured to, in response to determining that the similarity meets a threshold condition, identify the object at a position corresponding to the measured value in the target frame as the target object.

According to an exemplary implementation of the present disclosure, the tracking module includes: a second identification module configured to, in response to determining that the similarity does not meet a threshold condition, identify the object at a position corresponding to the measured value in the target frame as an object other than the target object.

According to an exemplary implementation of the present disclosure, the obtaining module is further configured to, for a next target frame subsequent to the target frame in the video, obtain a further set of previous positions of the target object in a further set of previous frames prior to the next target frame, respectively; the first determination module is further configured to determine, based on the further set of previous positions, a further predicted value of a position of the target object in the next target frame; the second determination module is further configured to determine a further measured value of a position of an object in the next target frame; and the tracking module is further configured to track the target object in the video based on a similarity between the further predicted value and the further measured value.

According to an exemplary implementation of the present disclosure, the obtaining module further comprises: a position obtaining module configured to take the measured value of the position of the target object determined from the target frame as the previous position of the target object in the target frame.

FIG. 10 illustrates a block diagram of a device 1000 capable of implementing multiple implementations of the present disclosure. It should be understood that the computing device 1000 shown in FIG. 10 is merely exemplary and should not constitute any limitation on the functionality and scope of the implementations described herein. The computing device 1000 shown in FIG. 10 may be used to implement the methods described above.

As shown in FIG. 10, computing device 1000 is in the form of a general purpose computing device. The components of computing device 1000 may include, but are not limited to, one or more processors or processing units 1010, a memory 1020, a storage device 1030, one or more communication units 1040, one or more input devices 1050, and one or more output devices 1060. The processing unit 1010 may be an actual or virtual processor and is capable of performing various processing based on the programs stored in the memory 1020. In a multiprocessor system, multiple processing units execute computer-executable instructions in parallel to improve the parallel processing capability of the computing device 1000.

The computing device 1000 typically includes multiple computer storage medium. Such medium may be any available medium that is accessible to the computing device 1000, including but not limited to volatile and non-volatile medium, removable and non-removable medium. The memory 1020 may be volatile memory (for example, a register, cache, a random access memory (RAM)), a non-volatile memory (for example, a read-only memory (ROM), an electrically erasable programmable read-only memory (EEPROM), a flash memory), or any combination thereof. The storage device 1030 may be any removable or non-removable medium, and may include a machine readable medium such as a flash drive, a disk, or any other medium, which may be used to store information and/or data (such as training data for training) and may be accessed within the computing device 1000.

The computing device 1000 may further include additional removable/non-removable, volatile/non-volatile storage medium. Although not shown in FIG. 10, a disk driver for reading from or writing to a removable, non-volatile disk (such as a “floppy disk”), and an optical disk driver for reading from or writing to a removable, non-volatile optical disk may be provided. In these cases, each driver may be connected to the bus (not shown) by one or more data medium interfaces. The memory 1020 may include a computer program product 1025, which has one or more program units configured to perform various methods or acts of various implementations of the present disclosure.

The communication unit 1040 communicates with a further electronic device through the communication medium. In addition, functions of components in the computing device 1000 may be implemented by a single computing cluster or multiple computing machines, which may communicate through a communication connection. Therefore, the computing device 1000 may be operated in a networking environment using a logical connection with one or more other servers, a network personal computer (PC), or another network node.

The input device 1050 may be one or more input devices, such as a mouse, a keyboard, a trackball, etc. The output device 1060 may be one or more output devices, such as a display, a speaker, a printer, etc. The computing device 1000 may also communicate with one or more external devices (not shown) through the communication unit 1040 as required. The external device, such as a storage device, a display device, etc., communicate with one or more devices that enable users to interact with the computing device 1000, or communicate with any device (for example, a network card, a modem, etc.) that makes the computing device 1000 communicate with one or more other electronic devices. Such communication may be executed via an input/output (I/O) interface (not shown).

According to example implementation of the present disclosure, a computer-readable storage medium is provided, on which a computer-executable instruction or computer program is stored, wherein the computer-executable instructions is executed by the processor to implement the method described above. According to example implementation of the present disclosure, a computer program product is also provided. The computer program product is physically stored on a non-transient computer-readable medium and includes computer-executable instructions, which are executed by the processor to implement the method described above.

Various aspects of the present disclosure are described herein with reference to the flow chart and/or the block diagram of the method, the apparatus, the device and the computer program product implemented in accordance with the present disclosure. It would be appreciated that each block of the flowchart and/or the block diagram and the combination of each block in the flowchart and/or the block diagram may be implemented by computer-readable program instructions.

These computer-readable program instructions may be provided to the processing units of general-purpose computers, specialized computers, or other programmable data processing devices to produce a machine that generates an apparatus to implement the functions/actions specified in one or more blocks in the flow chart and/or the block diagram when these instructions are executed through the computer or other programmable data processing apparatuses. These computer-readable program instructions may also be stored in a computer-readable storage medium. These instructions enable a computer, a programmable data processing apparatus and/or other devices to work in a specific way. Therefore, the computer-readable medium containing the instructions includes a product, which includes instructions to implement various aspects of the functions/actions specified in one or more blocks in the flowchart and/or the block diagram.

The computer-readable program instructions may be loaded onto a computer, other programmable data processing apparatus, or other devices, so that a series of operational steps may be performed on a computer, other programmable data processing apparatus, or other devices, to generate a computer-implemented process, such that the instructions which execute on a computer, other programmable data processing apparatuses, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a unit, a program segment or instructions, which contains one or more executable instructions for implementing the specified logic function. In some alternative implementations, the functions labeled in the block may also occur in a different order from those labeled in the drawings. For example, two consecutive blocks may actually be executed in parallel, and sometimes may also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Each implementation of the present disclosure has been described above. The above description is an example, not exhaustive, and is not limited to the disclosed implementations. Without departing from the scope and spirit of the described implementations, many modifications and changes are obvious to ordinary skill in the art. The selection of terms used in the present disclosure aims to best explain the principles, practical application or improvement of technology in the market of each implementation, or to enable other ordinary skill in the art to understand the various implementations disclosed herein.

1. A method of tracking a target object in a video based on an instance motion of the target object, comprising:
for a set of previous frames prior to a target frame in the video, obtaining a set of previous positions of the target object in the set of previous frames, respectively;
determining, based on the set of previous positions, a predicted value of a position of the target object in the target frame with a motion model;
determining a measured value of a position of an object in the target frame; and
tracking the target object in the video based on a similarity between the predicted value and the measured value.

2. The method of claim 1, wherein determining the predicted value of the position of the target object in the target frame comprises:
obtaining the motion model that describes an association between a position of an object in a target frame in a video and a set of positions of the object in a set of previous frames respectively prior to the target frame; and
determining, based on the motion model and the set of previous positions, the predicted value of the position of the target object in the target frame.

3. The method of claim 2, wherein obtaining the motion model comprises:
obtaining a reference position of a reference object in a target reference frame in a reference video, and a set of previous reference positions of the reference object in a set of previous reference frames respectively prior to the target reference frame; and
determining a motion feature in a repository in the motion model based on the reference position and the set of previous reference positions, the motion feature describing an association corresponding to the reference object.

4. The method of claim 3, further comprising: determining, based on the set of previous reference positions, a retrieval model in the motion model for retrieving from the repository a motion feature that matches the set of previous reference positions.

5. The method of claim 4, wherein determining the predicted value based on the motion model and the set of previous positions comprises:
retrieving, based on the retrieval model and the set of previous positions, a motion feature in the repository that matches the set of previous positions; and
determining, based on the retrieved motion feature, the predicted value of the position of the target object in the target frame.

6. The method of claim 5, wherein determining the predicted value further comprises:
updating the motion feature with a feature of the set of previous positions;
determining, based on the updated motion feature, the predicted value of the position of the target object in the target frame; and
updating the motion features with a feature of the measured value.

7. The method of claim 1, wherein tracking the target object based on the similarity comprises: in response to determining that the similarity meets a threshold condition, identifying the object at a position corresponding to the measured value in the target frame as the target object.

8. The method of claim 1, wherein tracking the target object based on the similarity comprises: in response to determining that the similarity does not meet a threshold condition, identifying the object at a position corresponding to the measured value in the target frame as an object other than the target object.

9. The method of claim 1, further comprising:
for a next target frame subsequent to the target frame in the video, obtaining a further set of previous positions of the target object in a further set of previous frames prior to the next target frame, respectively;
determining, based on the further set of previous positions, a further predicted value of a position of the target object in the next target frame;
determining a further measured value of a position of an object in the next target frame; and
tracking the target object in the video based on a similarity between the further predicted value and the further measured value.

10. The method of claim 9, wherein obtaining the further set of previous positions respectively comprises: taking the measured value of the position of the target object determined from the target frame as the previous position of the target object in the target frame.

11. An electronic device, comprising:
at least one processing unit; and
at least one memory coupled to the at least one processing unit and storing instructions for execution by the at least one processing unit, the instructions, when executed by the at least one processing unit, causing the electronic device to perform actions of tracking a target object in a video based on an instance motion of the target object, the actions comprising:
for a set of previous frames prior to a target frame in the video, obtaining a set of previous positions of the target object in the set of previous frames, respectively;
determining, based on the set of previous positions, a predicted value of a position of the target object in the target frame with a motion model;
determining a measured value of a position of an object in the target frame; and
tracking the target object in the video based on a similarity between the predicted value and the measured value.

12. The device of claim 11, wherein determining the predicted value of the position of the target object in the target frame comprises:
obtaining the motion model that describes an association between a position of an object in a target frame in a video and a set of positions of the object in a set of previous frames respectively prior to the target frame; and
determining, based on the motion model and the set of previous positions, the predicted value of the position of the target object in the target frame.

13. The device of claim 12, wherein obtaining the motion model comprises:
obtaining a reference position of a reference object in a target reference frame in a reference video, and a set of previous reference positions of the reference object in a set of previous reference frames respectively prior to the target reference frame; and
determining a motion feature in a repository in the motion model based on the reference position and the set of previous reference positions, the motion feature describing an association corresponding to the reference object.

14. The device of claim 13, the actions further comprising: determining, based on the set of previous reference positions, a retrieval model in the motion model for retrieving from the repository a motion feature that matches the set of previous reference positions.

15. The device of claim 14, wherein determining the predicted value based on the motion model and the set of previous positions comprises:
retrieving, based on the retrieval model and the set of previous positions, a motion feature in the repository that matches the set of previous positions; and
determining, based on the retrieved motion feature, the predicted value of the position of the target object in the target frame.

16. The device of claim 15, wherein determining the predicted value further comprises:
updating the motion feature with a feature of the set of previous positions;
determining, based on the updated motion feature, the predicted value of the position of the target object in the target frame; and
updating the motion features with a feature of the measured value.

17. The device of claim 11, wherein tracking the target object based on the similarity comprises: in response to determining that the similarity meets a threshold condition, identifying the object at a position corresponding to the measured value in the target frame as the target object; and
wherein tracking the target object based on the similarity comprises: in response to determining that the similarity does not meet a threshold condition, identifying the object at a position corresponding to the measured value in the target frame as an object other than the target object.

18. The device of claim 11, the actions further comprising:
for a next target frame subsequent to the target frame in the video, obtaining a further set of previous positions of the target object in a further set of previous frames prior to the next target frame, respectively;
determining, based on the further set of previous positions, a further predicted value of a position of the target object in the next target frame;
determining a further measured value of a position of an object in the next target frame; and
tracking the target object in the video based on a similarity between the further predicted value and the further measured value.

19. The device of claim 18, wherein obtaining the further set of previous positions respectively comprises: taking the measured value of the position of the target object determined from the target frame as the previous position of the target object in the target frame.

20. A non-transitory computer readable storage medium having stored thereon a computer program which, when executed by a processor, causes the processor to implement actions of tracking a target object in a video based on an instance motion of the target object, the actions comprising:
for a set of previous frames prior to a target frame in the video, obtaining a set of previous positions of the target object in the set of previous frames, respectively;
determining, based on the set of previous positions, a predicted value of a position of the target object in the target frame with a motion model;
determining a measured value of a position of an object in the target frame; and
tracking the target object in the video based on a similarity between the predicted value and the measured value.
